(19) United States
(12) Patent Application Publication
(10) Pub. No.: US 2005/0213201 A1
(43) Pub. Date: Sep. 29, 2005

(54) Apparatus for fixing a microscope holder

(76) Inventors: Heinz Zimmermann, Balgach (CH); Otto Geschwentner, Balgach (DE); Peter Soppelsa, Rebstein (CH); Stephan Keller, Salmsach (CH)

Correspondence Address: HODGSON RUSS LLP, ONE M & T PLAZA, SUITE 2000, BUFFALO, NY, 14203-2391, US

(21) Appl. No.: 11/091,143

(22) Filed: Mar. 28, 2005

(30) Foreign Application Priority Data
Mar. 29, 2004 (DE) 20 2004 004 894.9

(51) Int. Cl. C02F 1/38; B01D 33/00; B01D 35/00; B01D 35/22; G02B 21/00

(52) U.S. Cl. 359/368; 359/384

(57) ABSTRACT

An apparatus for fixing a microscope holder on a carrier includes both a clamping device for holding the microscope holder in a selected position relative to the carrier, and a locking device for securing the microscope holder to the carrier especially while the clamping device is released during positioning of the microscope holder relative to the carrier. Accordingly, accidental dropping of the microscope holder or disconnection of the microscope holder from the carrier is prevented.

### CROSS-REFERENCE TO RELATED APPLICATIONS

This application claims priority of the German utility model application number 20 2004 004 894.9 filed Mar. 29, 2004.

### FIELD OF THE INVENTION

The present invention relates to an apparatus for fixing a microscope holder to a carrier, in which a clamping device is provided for holding the microscope holder in the selected position. Apparatus of this kind are used, for example, to connect a microscope attached to a microscope holder to a pivot arm rotatably mounted on a column which is in turn supported by a baseplate. The pivot arm is pivotable about the column and is adjustable in height relative to the baseplate. On pivoting arm stands of this kind the apparatus is used for securely holding microscope holders.

### BACKGROUND OF THE INVENTION

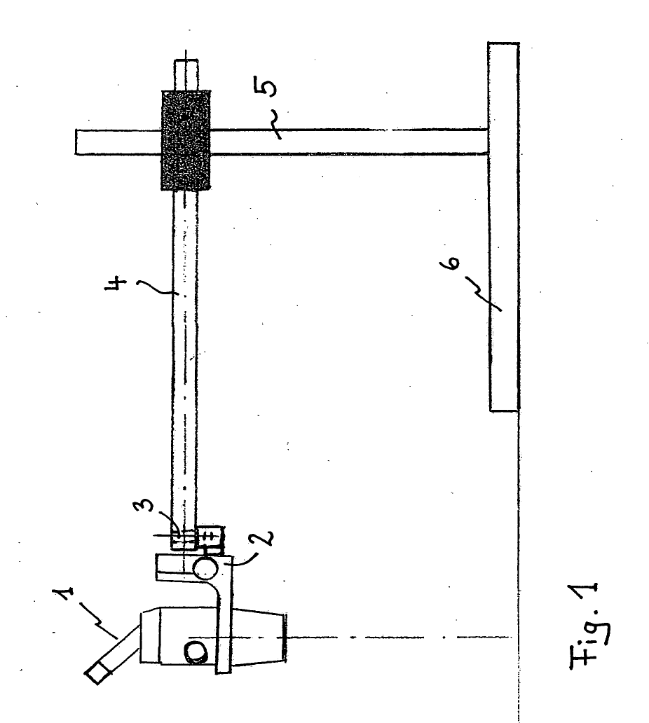

A diagrammatic view of a pivoting arm stand with microscope is shown in FIG. 1. The microscope holder 2 carries a microscope 1 and is in turn secured to the pivot arm 4 of the pivot arm stand. The column 5 emerging from the baseplate 6 carries the pivot arm 4 and microscope holder 2. The drawing shows a microscope holder 2 which has to be mounted from below on the carrier which in this case is integrated in the end of the pivot arm 4. Other methods of fixing a microscope holder are also known in which the fixing can be done by means of the bolt from above or from in front, i.e. in the horizontal direction. It is desirable that the microscope holder 2 should be rotatable about the axis of the bolt 3 to allow adjustment of the position of the microscope 1.

Up till now the microscope holder has been secured by means of a clamping device which holds the microscope holder in a selected position (operating position) on the carrier. Particularly when it is secured from below (see FIG. 1) there is a danger, when undoing a clamping device of this kind in order to change the operating position, that the bolt will come away from the carrier and as a result the microscope holder together with the microscope will fall. Thus, when it is rotated about the bolt axis, i.e. when varying the operating position, the customer has no operational reliability.

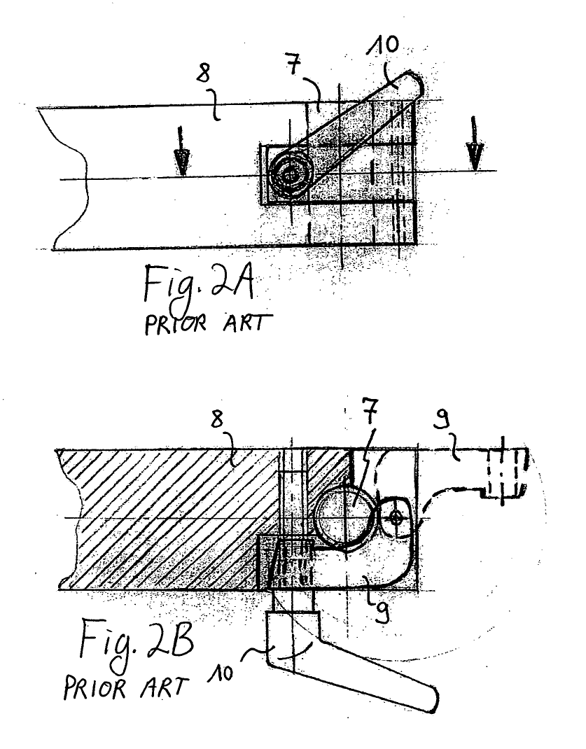

FIGS. 2A and 2B show a known fixing apparatus for a microscope holder having a clamping device of the kind described above. In this known solution the bolt of the microscope holder is preferably introduced through the receiving bore 7 in the carrier 8 from below, for which purpose the clamping lug 9 has to be pivoted outwards until the inside of the receiving bore 7 is exposed. The bolt of the microscope holder introduced into the receiving bore 7 is then clamped in position by pivoting the clamping lug 9 back in. As a rule the bolt of the microscope holders have an indentation on their outer surface in which the link or gate of the clamping lug 9 can engage. The clamping action of the clamping lug 9 can be increased by tightening the screw fixing 10. The operation position can then be adjusted by loosening the screw connection 10.

In this known fixing apparatus the clamping lug or plate of which is made of plastics, there is a danger that the bolt of the microscope holder will come away from the clamping lug or plate entirely when the screw fixing 10 is loosened on account of the flowing plastic. Due to the elasticity of the plastic and its low resistance to wear the clamping action of the known device decreases over time. It is not really possible to fix the microscope holder from above owing to the need to pivot the clamping lug outwards for fixing purposes, as the lug would collide with the microscope holder. Horizontal fixing is nor possible with the known device. Other disadvantages are related to the presence of parts which may be lost (screw fixing 10) and the ergonomic design.

### SUMMARY OF THE INVENTION

An object of the present invention is to provide a safe apparatus for fixing a microscope holder with which a microscope holder can be fixed horizontally (from in front) and vertically (from above and below) to a carrier for various kinds of microscope holders. The apparatus according to the invention should primarily provide a high degree of safety for the user and be ergonomically well designed and have a long service life or durability.

The central idea of the present invention is to additionally provide the known apparatus with a locking device for securing the microscope holder to the carrier. This clearly separates the functions of undoing (in order to adjust an operating position) and releasing (for mounting and demounting a microscope holder). This increases the operational safety and reliability.

In a first embodiment of the invention the carrier has a receiving bore for a bolt of a microscope holder, this bolt having an internal thread. The locking device comprises a screw which is to be screwed into the internal thread of the bolt. For secure fastening, in this embodiment, the bolt of the microscope holder is consequently screwed to the carrier while independently thereof the position of the microscope holder can be adjusted by means of a clamping device. The locking device, in this case the screw connection, is only undone in order to remove the microscope holder. In this particular embodiment care must be taken in certain cases to ensure that the strength of the screw connection will still allow the bolt to be turned in order to alter the operating position when the clamping device is loosened accordingly.

An advantageous feature of this embodiment is the use of a standard commercial screw with washer, the external diameter of the washer being greater than the diameter of the receiving bore for the bolt, so that the washer bears against the carrier when the screw is turned.

It is preferable if the clamping device has a clamping screw which can be screwed through the carrier into the interior of the receiving bore for the bolt, the direction of screwing of the clamping screw preferably extending perpendicularly to the direction of the receiving bore for the bolt. The bolt may be inserted vertically or horizontally into a corresponding receiving bore on the carrier, while the clamping screw is screwed into the carrier perpendicularly thereto (from the side) until it reaches the bolt in the receiving bore and clamps it in position.

As the bolts used for the microscope holder generally have an indentation of about 1 mm in part of their outer surface it is advantageous if the clamping screw is constructed on its end face so that it can press into the indentation on the bolt. Tightening the clamping screw causes frictional connection with the bolt of the microscope holder. By loosening the clamping screw it is possible to rotate the microscope holder. During the rotation of the microscope holder, according to the invention, the microscope holder remains firmly attached to the carrier as the actuation of the clamping device has no effect on the locking device.

In a second embodiment the carrier again has a receiving bore which is to be brought into engagement with a bolt of the microscope holder, the locking device having a spring loaded slide which in its locking position projects into the interior of the receiving bore for the bolt. In this embodiment the locking function is performed by a slide which presses with spring force against a bolt located in the receiving bore. Preferably, the receiving bore for the slide extends perpendicularly to the (vertical) receiving bore for the bolt of the microscope holder.

It is expedient to construct the end face of the slide such that in the locking position it snaps into a lateral indentation on the bolt of the microscope holder.

In order to mount the microscope holder on the carrier, the slide is pushed back counter to the spring force so that the receiving bore for the bolt is exposed. In order to do this it is useful if the locking device has a parking position in which the slide, without the application of force, does not project into the interior of the receiving bore for the bolt of the microscope holder.

The clamping device may be constructed in the same way as in the first embodiment.

In this case it is advantageous if the direction of screwing of the clamping screw extends perpendicularly to the direction of the receiving bore for the slide of the locking device. In this way the receiving bore for the bolt in a vertical fixing, the receiving bore for the slide of the locking device and the bore of the thread of the clamping screw may be perpendicular to one another, thereby achieving an ergonomically reasonable arrangement of the components.

In a third embodiment the carrier has a receiving bore for a bolt of the microscope holder and the locking device contains a rotationally mounted clamping lug or plate which can be pivoted into a locking position in which the clamping lug or plate holds the bolt inside the receiving bore.

In this embodiment the locking device is essentially formed by a rotationally mounted clamping lug which locks the bolt introduced into the receiving bore in the carrier, i.e. secures it against becoming detached from the carrier.

For this purpose the bolt preferably has a lateral indentation and the clamping lug has a correspondingly shaped link or gate (or profile) so that in the locking position the part of the clamping lug link projecting into the receiving bore for the bolt engages in the lateral indentation on the bolt and secures it in this way.

To achieve a high degree of safety in this embodiment it is advantageous if the major part of the pivot area of the clamping lug leads to a locking position of the locking device, whereas the other part leads to a release position in which the bolt of the microscope holder is freely movable in the receiving bore in the carrier. Again it is advantageous if the clamping lug only releases the bolt in a single position.

A safe locking action can be achieved particularly when the clamping lug is made of metal.

In this third embodiment the clamping device may again be essentially formed by a clamping screw which is preferably constructed to be non-losable, and when the clamping screw is loosened the microscope holder can be moved into a specific operating position while being securely held on the carrier by the locking device. The clamping screw can also be screwed back through the carrier into the interior of the receiving bore for the bolt in this case too and, when the bolt is inserted, holds it in a specific position by frictional engagement.

In another form of this embodiment the clamping screw does not engage in the receiving bore for the bolt of the microscope holder but engages in an internal thread of the clamping lug of the locking device. The clamping lug which locks the bolt is pressed against the bolt by tightening the clamping screw so that the microscope holder is held in the chosen position by frictional and interlocking (form-fit) engagement with the link or gate of the clamping lug.

It should be pointed out that in this embodiment, too, slackening or loosening of the clamping screw cannot lead to accidental release of the bolt as the clamping screw can only be brought into screw connection with the clamping lug if it is in a locking position. Only when the clamping screw is undone and the clamping lug has been pivoted into a release position can the bolt of the microscope holder become detached from the carrier.

In a fourth embodiment the carrier again comprises a receiving bore for a bolt of a microscope holder which is to be brought into engagement with this receiving bore, the locking device now containing a spring loaded clamping pincer which in its locking position holds the bolt of the microscope holder within the receiving bore.

In this embodiment it is useful if the spring loaded clamping pincer is mounted to be rotatable about a rotation axis and supported at one end on a spring, while the other end of the pincer comprises a link or gate which is constructed for safely locking to the bolt of the microscope holder. It is also advantageous if the clamping pincer is in its locking position when at rest and if, by actuating the clamping pincer counter to the spring force, the clamping pincer can be brought into a release position in which it releases the bolt which is located in the receiving bore in the carrier.

In this fourth embodiment the clamping device may in turn be formed by a clamping screw which can be screwed into the interior of the receiving bore for the bolt, where it holds the bolt in the selected position by frictional engagement. The link of the clamping pincer is constructed so that when the clamping screw is undone the bolt is able to rotate in the receiving bore.

In this embodiment it may be useful to provide a fixing screw which prevents the clamping pincer from being actuated towards the release position. For this, the fixing screw suitably extends parallel to the spring on which the clamping pincer is supported, so that the clamping pincer can only be actuated counter to spring force when the fixing screw is undone.

In the apparatus according to the invention it is advantageous if the carrier has two receiving bores for a bolt of a microscope holder, which are perpendicular to one another. In this way it is possible to select either vertical or horizontal fixing of a microscope holder, i.e. the bolt of the microscope holder may be inserted from above, from below or from the front in the horizontal direction into the receiving bore in the carrier.

The invention and its advantages will now be described more fully with reference to the embodiments shown in the drawings, wherein:

FIG. 1 is a side elevational view of a pivot arm stand with microscope;

FIG. 2A is an elevational view of a known apparatus for fixing a microscope holder to a carrier;

FIG. 2B is a sectional view of the known apparatus shown in FIG. 2A;

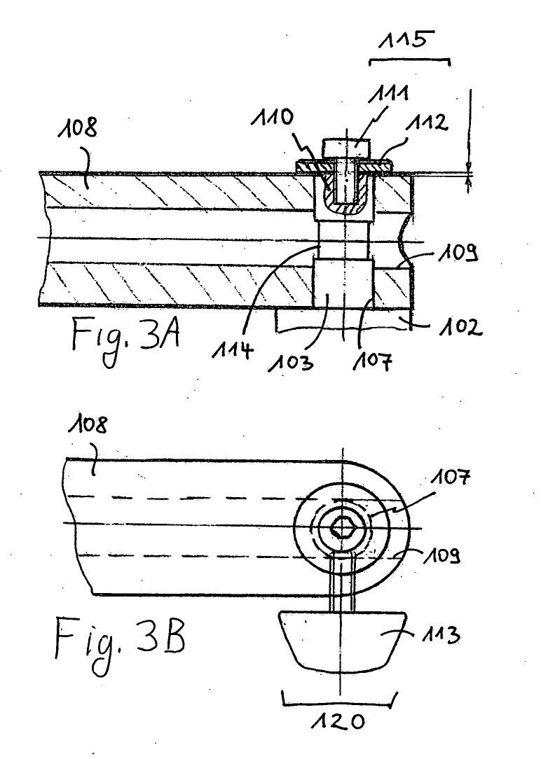

FIG. 3A is a sectional view of a fixing apparatus formed in accordance with a first embodiment of the present invention;

FIG. 3B is a top plan of the fixing apparatus shown in FIG. 3A;

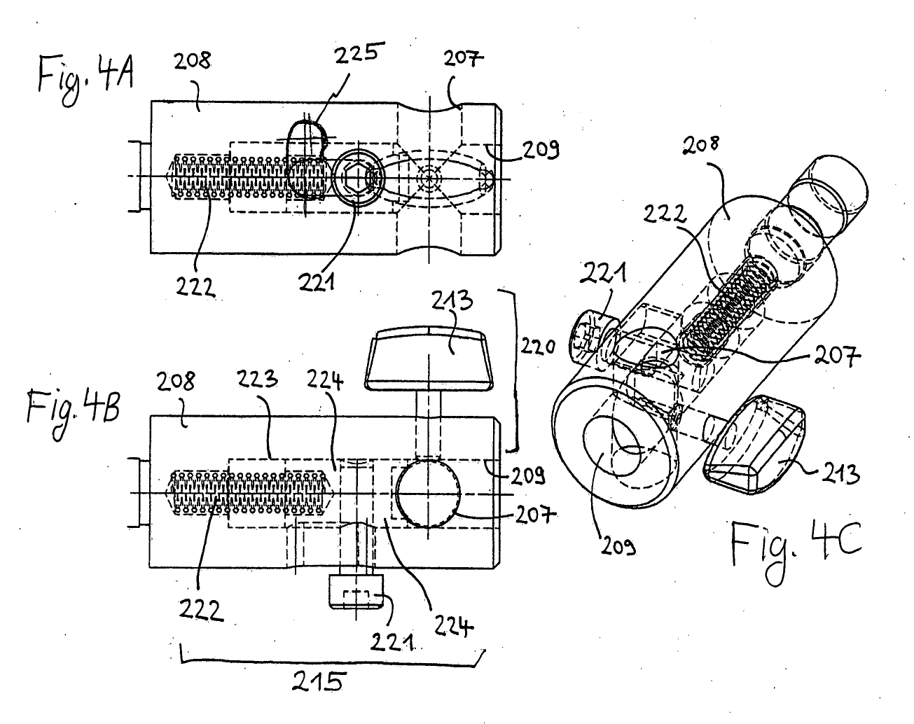

FIG. 4A is a sectional view of a fixing apparatus formed in accordance with a second embodiment of the present invention;

FIG. 4B is a top plan of the fixing apparatus shown in FIG. 4A;

FIG. 4C is a perspective view of the fixing apparatus shown in FIGS. 4A and 4B;

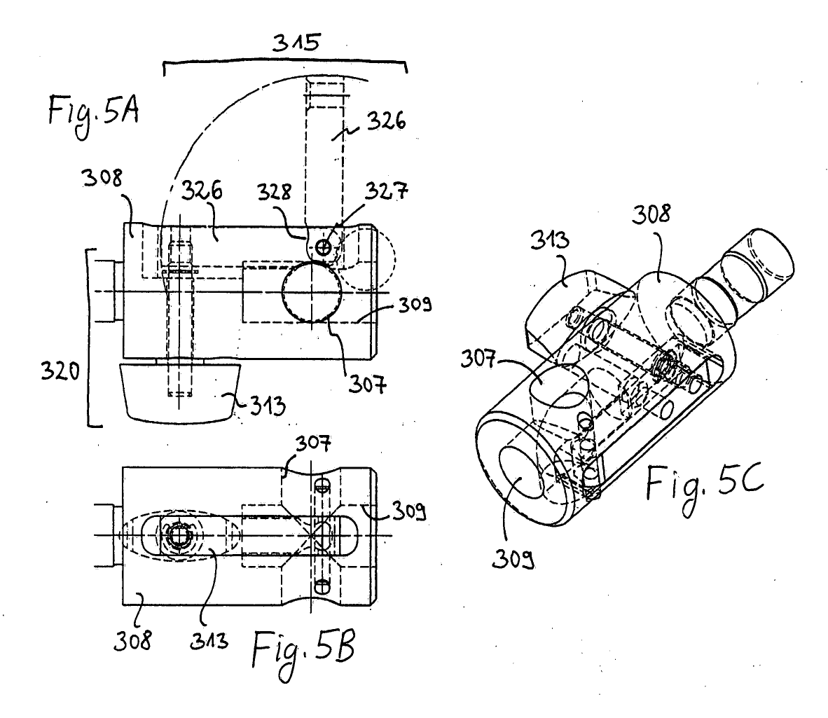

FIG. 5A is a top plan view of a fixing apparatus formed in accordance with a third embodiment of the present invention;

FIG. 5B is a side elevational view of the fixing apparatus shown in FIG. 5A;

FIG. 5C is a perspective view of the fixing apparatus shown in FIGS. 5A and 5B;

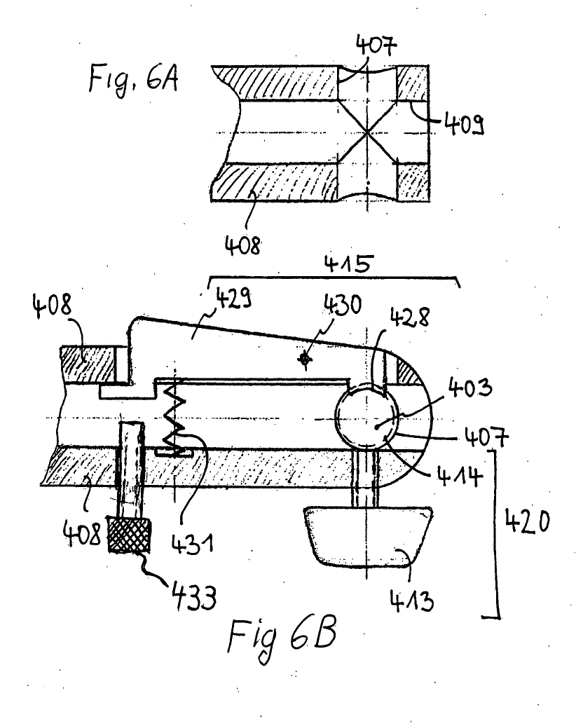

FIG. 6A is a sectional view showing a carrier of a fixing apparatus formed in accordance with a fourth embodiment of the present invention, where the carrier has different connection possibilities for a microscope holder;

FIG. 6B is a top plan view, partially sectioned, of a fixing apparatus formed in accordance with the fourth embodiment of the present invention, wherein the microscope holder is mounted vertically;

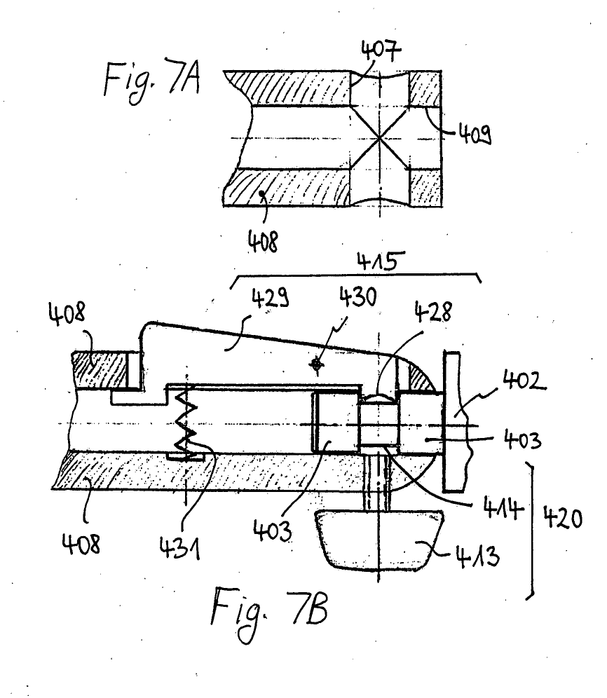

FIG. 7A is a sectional view showing a carrier of a fixing apparatus formed in accordance with a fourth embodiment of the present invention, where the carrier has different connection possibilities for a microscope holder; and

FIG. 7B is a top plan view, partially sectioned, of a fixing apparatus formed in accordance with the fourth embodiment of the present invention, wherein the microscope holder is mounted horizontally.

### DETAILED DESCRIPTION OF THE INVENTION

FIGS. 1, 2A and 2B have already been discussed in the introduction to the description in conjunction with the problems underlying the invention.

The four embodiments of the invention will hereinafter be explained more fully with reference to FIGS. 3 to 7 with the advantageous features illustrated therein.

### First Embodiment

FIG. 3 shows part of a carrier 108 with-the fixing apparatus according to the invention for a microscope holder, essentially consisting of a clamping device 120 and a locking device 115. FIGS. 3A and 3B show the same detail but viewed in different ways. FIG. 3A shows a cross section through the bolt 103 of a microscope: holder 102 which engages vertically from below in a corresponding receiving bore 107 in the carrier. The locking device 115 according to the invention essentially comprises a screw 111 with washer 112 which serves to secure the bolt 103 to the carrier 108. For this purpose the bolt 103 has an internal thread 110 into which the screw 111 can be screwed. In the example shown the washer 112 is supported on the edge of the vertical receiving bore 107 for the bolt. In the position shown in FIG. 3A the bolt is rotatable about its axis so that an operating position can be selected by rotating the microscope holder 102 about the axis of the bolt.

In the first embodiment illustrated, the clamping screw 113 forms the major part of the clamping device 120. Once the desired operating position has been selected further rotation of the bolt 103 about its axis is prevented by tightening the clamping screw 113. In the embodiment shown, this clamping screw can be screwed into the vertical receiving bore 107 for the bolt, perpendicularly to said bore 107, so as to have its end face pressed against the surface of the bolt. As a rule the bolts 103 of the microscope holders 102 have a lateral indentation 114. It is useful if the end face of the clamping screw 113 is constructed so that the end face presses into this lateral indentation 114 and holds the bolt in place by frictional engagement. FIG. 3B diagrammatically shows the bolt clamped in position.

Theoretically, the embodiment of the invention illustrated can also be applied to horizontal fixing of the microscope holder. For this, the bolt of the microscope holder is inserted in the horizontal receiving bore 109. On the other hand, with this type of fixing, the locking device does not necessarily have to be operated as it is not very likely that the microscope holder will accidentally drop out when the clamping device is undone as this would require the bolt to be fully removed from the receiving bore 109. Consequently, the first embodiment shown is suitable particularly for the vertical fixing of the microscope holder, i.e. particularly when the bolt is inserted from below.

The first embodiment of the invention is particularly noticeable for its simplicity, as the locking device requires only a screw and washer while the bolt of the microscope holder has to be provided with a corresponding internal thread. It should be specifically mentioned at this point that the screw connection shown might be replaced by other mechanical forms of connecting bolts and carriers, such as suitable push-fit connections or a magnetic connection.

### Second Embodiment

FIG. 4 shows a second embodiment of the invention viewed in different ways. The carrier 208 shown is illustrated here such that it might be mounted on a carrying arm such as a pivot arm 4 (cf. FIG. 1). However, it may also be integrated in the end of the pivot arm. The carrier 208 has two receiving bores 207, 209 for the vertical and horizontal fixing of a microscope holder. The plan view shown in FIG. 4B clearly shows the slide 224 which is operable by means of a latching bolt 221 and which is mounted on a spring 222 (or any other suitable element which exerts a restoring force). The spring 222 and slide 224 are mounted in corresponding receiving bores inside the carrier 208. The latching bolt 221, slide 224 and spring 222 here form the essential elements of the locking device 215 according to the invention. The end of the slide 224 remote from the spring 222 has an end face which is suitable for securely holding a bolt of a microscope holder which has been inserted in the vertical receiving bore 207 in position, while still allowing the microscope holder to rotate about the bolt axis. In the embodiment shown the end face of the slide 224 snaps into a lateral indentation on the bolt of the microscope holder. Whereas the diameter of the bolt is generally 15.8 mm, the diameter of the lateral indentation is generally 14.0 mm. The shoulders measuring 0.9 mm deep which are thus formed are ideally suited to holding the bolt securely on the carrier 208 by snapping the slide into the indentation.

A suitable operating position for the microscope holder can be selected by rotating it about the axis of the bolt. Then the microscope holder is fixed by the clamping device, in this case essentially the clamping screw 213. As in the first embodiment the clamping screw is screwed perpendicularly to the vertical receiving bore 207 through the carrier 20& into the receiving bore 207, where it is held by frictional engagement by the bolt located therein. Again, undoing the clamping screw 213 cannot lead to accidental release of the bolt from the receiving opening 207.

In order to insert a bolt into the receiving bore 207 and remove it therefrom the latching bolt 221 is pushed backwards against the pushing force of the spring 222 so that the bolt in the receiving bore 207 is released or exposed. To make the operation easier it is advisable to provide a parking position 225 for the slide 224, for example by having a suitable recess milled in the carrier to the side of the direction of insertion. The latching bolt 221 is then guided into this recess so that the user does not have to hold the latching bolt 221 against the pushing force of the spring 222 when adjusting the microscope holder.

The embodiment shown is also suitable for horizontal mounting of the microscope holder for which the bolt of the microscope holder is pushed into the receiving bore 209. For this purpose the bolting function of the locking device 215 is usefully deactivated, e.g. by moving the latching bolt 221 into its parked position 225. The bolt can then engage far enough into the receiving bore 209 and be held in a selected operating position by means of the clamping screw.

### Third Embodiment

FIG. 5 shows the third embodiment of the invention viewed in different ways. The locking device 315 is essentially formed by a clamping lug or plate 326 whereas the clamping device 320 is essentially formed by a clamping screw 313 which in this case interacts with the locking device 315. FIG. 5A shows a plan view of this third embodiment, showing the clamping lug 326 in two different positions. The clamping lug 326 is rotatably mounted, the centre of rotation being designated 327. In the embodiment shown the centre of rotation is close to the vertical receiving bore 307.

For the purpose of describing the locking action it is assumed, as in the previous embodiments, that the bolt of the microscope holder has a lateral indentation. The link or gate 328 of the clamping lug or plate 326 is shaped so that it securely locks any bolt inserted (vertically or horizontally) in the receiving bore in the carrier. For this purpose the link 328 engages in the lateral indentation on the bolt when the clamping lug 326 is brought into the locking position. In the embodiment shown here the clamping lug has to be pivoted out through 90° in order to allow the microscope carrier to be mounted and demounted, in all the insertion variants. Pivoting of the clamping lug 326 immediately results in a locking action which provides almost total protection against accidental release of the bolt.

In the embodiment shown the clamping device 320 is coupled to the locking device 315 by the clamping screw 313 which engages in a thread in the clamping lug. The clamping screw 313 is expediently secured to the carrier 308 so that it cannot be lost. By tightening the clamping screw 313 the clamping lug 326 is pulled more strongly into the interior of the carrier so that the pressure on the locked bolt increases. By tightening the clamping screw 313 this pressure can be increased so that any change in the position of the microscope holder by rotating about the axis of the bolt can be totally prevented.

It is important to point out that in this embodiment, loosening or even undoing the clamping screw 313 cannot lead to accidental release of a bolt from the receiving bore as this would additionally require the clamping lug 326 to be pivoted through 90°.

FIG. 5B shows a side elevational view of the third embodiment shown in FIG. 5A. FIG. 5C shows a perspective view of this embodiment.

### Fourth Embodiment

FIGS. 6 and 7 show another variant in which the locking device is essentially formed by a clamping pincer and the clamping device is essentially formed by a clamping screw. The clamping pincer is designated 429 and the clamping screw 413. FIGS. 6A and 7A show the basic structure of the carrier 408 with the two receiving bores 407 and 409 for vertical and horizontal fixing of a microscope holder. FIG. 6B shows the set up for vertical mounting of the microscope holder while FIG. 7B shows the set up for horizontal mounting of the microscope holder.

In the fourth embodiment shown the locking device 415 is formed by clamping pincer 429 which is mounted to rotate about a rotation axis 430, one end of the clamping pincer 429 resting on a spring 431. The end of the clamping pincer 429 remote from the spring 431 engages, in the locking position thereof, inside the receiving bore 407 (cf. the plan view in FIG. 6B). The link or gate 428 (or more generally the profile) of the clamping pincer 429 is constructed accordingly so as to form a secure connection, for example, with a lateral indentation on the bolt 403 of the microscope holder. Only by pressing the other end of the clamping pincer 429 counter to the force of the spring 431 is the bolt 403 released inside the receiving bore 407 and is freed. To ensure maximum safety the link or gate 428 is shaped so that the bolt 403 is only released when the clamping pincer 429 is pressed down fully against the spring 431.

In the fourth embodiment shown the clamping device 420 is identical in structure to the clamping devices of the first and second embodiment.

FIG. 7B shows the fourth embodiment with a horizontally mounted microscope holder 402, viewed from the same aspect as FIG. 6B. The link or gate 428 of the clamping pincer 429 is shaped accordingly so as to secure the indentation 414 of the bolt 403 both during vertical fixing and during horizontal fixing (interlocking and/or frictional engagement). In both types of fixing, the link 428 is able to engage in the indentation 414 on the bolt 403 such that when the clamping screw 413 is loosened or undone it is impossible for the microscope holder to be removed or fall out of the carrier 408 accidentally.

In one modification, as shown in FIG. 6B, a fixing screw 433 is provided extending parallel to the spring 431 and on the same side of the lever, and coming to abut on the underside of the clamping pincer 429 when screwed in while making it possible to press the clamping pincer down counter to spring force. A fixing screw of this kind can provide protection against accidental pressing of the clamping pincer.

In all the embodiments shown it is expedient to form the parts of the locking device which produce the locking action from a non-yielding material such as metal so as to achieve a reliable locking action and a long service life. The invention particularly makes it possible to achieve an effective locking action when vertical assembly is used in addition to the known clamping action, so that it is impossible for the microscope holder to become accidentally detached from the carrier. Consequently the invention increases the operating safety. Finally, the invention opens up various possible ways of mounting the microscope holder while achieving an ergonomically favourable design for the carrier.

### LIST OF REFERENCE NUMERALS

1 Microscope
2, 102, 402 Microscope holder
3, 103, 403 Bolt of the microscope holder
4 Pivot arm
5 Column
6 Baseplate
7, 107, 207, 307, 407 Receiving bore for bolts (vertical)
8, 108, 208, 308, 408 Carrier
9 Clamping lug
10 Screw connection
109, 209, 309, 409 Receiving bore for bolts (horizontal)
110 Internal thread in the bolt
111 Screw
112 Washer
113, 213, 313, 413 Clamping screw
114, 414 Indentation on the bolt
115, 215, 315, 415 Locking device
120, 220, 320, 420 Clamping device
221 Latching bolt
222 Spring
223 Receiving bore for slide
224 Slide
225 Parked position for slide
326 Clamping lug
327 Centre of rotation
328 Link of the clamping lug
428 Link of the clamping pincer
429 Clamping pincer
430 Rotation axis of the clamping pincer
431 Spring
433 Fixing screw

1. An apparatus comprising:
a microscope holder;
a carrier;
a clamping device for holding the microscope holder in a selected position relative to the carrier; and
a locking device for securing the microscope holder to the carrier;
wherein the clamping device can be released to allow positioning of the microscope holder while the locking device continues to secure the microscope holder to the carrier.

2. The apparatus according to claim 1, wherein the clamping device includes a clamping screw.

3. The apparatus according to claim 1, wherein the carrier includes a receiving bore, the microscope holder includes a bolt received by the receiving bore, the bolt has an internal thread, and the locking device includes a screw threadably mating with the internal thread of the bolt.

4. The apparatus according to claim 3, wherein the locking device further includes a washer having an external diameter greater than a diameter of the receiving bore of the carrier.

5. The apparatus according to claim 3, wherein the clamping device includes a clamping screw for releasably engaging the bolt in the receiving bore.

6. The apparatus according to claim 5, wherein the clamping screw is threadably adjustable in a direction perpendicular to an axial direction of the receiving bore for the bolt.

7. The apparatus according to claim 1, wherein the carrier includes a receiving bore, the microscope holder includes a bolt received by the receiving bore, and the locking device includes a spring-loaded slide biased toward a locking position in which the slide engages the bolt to hold the bolt inside the receiving bore.

8. The apparatus according to claim 7, wherein the carrier includes a second receiving bore that receives the slide and extends perpendicularly to the receiving bore for the bolt of the microscope holder.

9. The apparatus according to claim 7, wherein the bolt of the microscope holder has a lateral indentation, and the slide of the locking device has an end face configured to mate with the lateral indentation of the bolt.

10. The apparatus according to claim 7, wherein the slide can be moved into a parked position (225) in which it does not project into the receiving bore for the bolt.

11. The apparatus according to claim 10, wherein the slide includes a latching bolt for use in moving the slide to its parked position.

12. The apparatus according to claim 7, wherein the clamping device includes a clamping screw for releasably engaging the bolt in the receiving bore.

13. The apparatus according to claim 12, wherein the clamping screw is threadably adjustable in a direction perpendicular to an axial direction of the receiving bore for the bolt.

14. The apparatus according to claim 13, wherein the clamping screw is threadably adjustable in a direction perpendicular to an axial direction of the second receiving bore for the slide.

15. The apparatus according to claim 1, wherein the carrier includes a receiving bore, the microscope holder includes a bolt received by the receiving bore, and the locking device includes a rotationally mounted clamping lug that when pivoted into a locking position holds the bolt inside the receiving bore for the bolt.

16. The apparatus according to claim 15, wherein the bolt of the microscope holder has a lateral indentation, and the clamping lug has a link that engages in the lateral indentation of the bolt when the clamping lug is in a locking position.

17. The apparatus according to claim 16, wherein the clamping lug can be pivoted into a release position in which the link is removed from the lateral indentation of the bolt.

18. The apparatus according to claim 17, wherein the link of the clamping lug is configured so that a majority of possible angular positions of the clamping lug correspond to a locking position and a minority of possible angular positions of the clamping lug correspond to a release position.

19. The apparatus according to claim 15, wherein the clamping lug is made of metal.

20. The apparatus according to claim 16, wherein the clamping device includes a clamping screw threadably mating with a threaded hole in the clamping lug such that the clamping screw is operable to adjust frictional force between the link of the clamping lug and the bolt of the microscope holder for selectively securing the bolt in position by frictional engagement with the link.

21. The apparatus according to claim 1, wherein the carrier includes a receiving bore, the microscope holder includes a bolt received by the receiving bore, and the locking device includes spring-loaded clamping pincer biased toward a locking position in which the pincer holds the bolt inside the receiving bore.

22. The apparatus according to claim 21, wherein the bolt of the microscope holder has a lateral indentation and the clamping pincer has a link which engages in the lateral indentation of the bolt when the pincer is in the locking position.

23. The apparatus according to claim 21, wherein the clamping pincer can be moved counter to the spring load into a release position in which the pincer does not hold the bolt inside the receiving bore.

24. The apparatus according to one of claims 21, further comprising a fixing screw adjustable to engage the pincer to prevent actuation of the clamping pincer from its locking position.

25. The apparatus according to one of claim 21, wherein the clamping device includes a clamping screw for releasably engaging the bolt in the receiving bore.

26. The apparatus according to claim 25, wherein the clamping screw is threadably adjustable in a direction perpendicular to an axial direction of the receiving bore for the bolt.

27. The apparatus according to claim 1, wherein the carrier includes two receiving bores extending perpendicular to one another, and the microscope holder includes a bolt received by a chosen one of the two receiving bores.
